(19) United States
(12) Patent Application Publication
(10) Pub. No.: US 2025/0290761 A1
(43) Pub. Date: Sep. 18, 2025

(54) Navigating A Vehicle During A Journey With A Vehicle Transport

(71) Applicant: Joynext GmbH, Dresden (DE)

(72) Inventor: Karl Fellerer, Dresden (DE)

(21) Appl. No.: 19/040,943

(22) Filed: Jan. 30, 2025

(30) Foreign Application Priority Data
Mar. 13, 2024 (DE) 102024107127.3

(51) Int. Cl. G01C 21/34; G06Q 10/02; G06Q 10/0835

(52) U.S. Cl. CPC G01C 21/3423; G06Q 10/02; G06Q 10/08355

(57) ABSTRACT

The invention relates to a method for navigating a vehicle using a satellite-based navigation program to a destination, wherein the journey to the destination includes a vehicle transport of the vehicle. The method stores vehicle data relating to the vehicle and user data relating to a user of the vehicle in the navigation program, enters the destination into the navigation program by the user, determines a route to the destination with a route section to be covered by a vehicle transport of the vehicle by the navigation program, determines an estimated time of arrival of the vehicle at a starting location of the vehicle transport by the navigation program, and books a vehicle transport following the estimated arrival time by the navigation program using stored vehicle data and/or user data.

The invention relates to a method for navigating a vehicle to a destination using a satellite-based navigation program, wherein the journey to the destination comprises a vehicle transport of the vehicle

### BACKGROUND

A navigation program is a computer program that is able to calculate a route for a vehicle that leads from a starting position to a destination. The navigation program is executed, for example, on a control unit of the vehicle or a mobile terminal of a user of the navigation program. The destination is usually determined by the user of the navigation program. The start position can also be defined by the user. Alternatively, the starting position can be a current position of the vehicle, for example. A satellite-based navigation program is understood to be a navigation program that determines the position of the vehicle using a navigation satellite system, for example using GPS, GLONASS, Beidou or Galileo.

Furthermore, the navigation program can be set up to provide the user with route guidance based on a route. The term “route guidance” refers to a process in which the user is guided along the route. During route guidance, route guidance instructions are issued to the user. A route guidance instruction can be given to the user visually and/or acoustically. Visual route guidance instructions often include a representation of the route or a route section of the route on a display unit. Furthermore, visual route guidance instructions can include, for example, arrow symbols that indicate a direction of travel, in particular a change in the direction of travel, and/or overlays that indicate upcoming driving maneuvers. Acoustic route guidance instructions are often issued as voice messages via a loudspeaker unit. A typical acoustic guidance message is, for example, “turn left in 200 meters”.

A route can have a route section that requires the vehicle to be transported. During vehicle transportation, the vehicle is transported by means of a watercraft or a rail vehicle, for example. The vehicle transport may be necessary, for example, to reach the destination or to shorten the journey to the destination. Vehicle transportation is necessary to reach the destination, for example, if the vehicle is a passenger car, the starting position of the route is on a mainland and the destination is on an island to which there is no bridge or tunnel from the mainland that can be accessed by the vehicle. A vehicle transport that shortens the journey to the destination is given, for example, if reaching the destination without the vehicle transport requires a considerable detour and/or a considerable amount of time

Vehicle transportation is usually subject to a charge and is often tied to specific times when a means of transport is available to carry out the vehicle transportation. Furthermore, vehicle transportation may require a reservation. Carrying out a journey with a vehicle transport therefore often requires preparation and planning of the journey that goes beyond the preparation and planning of a journey without a vehicle transport.

### SUMMARY

The invention is based on the task of providing an improved method for navigating a vehicle to a destination using a satellite-based navigation program, if the journey to the destination comprises a vehicle transport of the vehicle.

The problem is solved according to an embodiment of the invention by a method for navigating a vehicle to a destination using a satellite-based navigation program, the journey to the destination comprising a vehicle transport of the vehicle, including the steps of:
storing vehicle data relating to the vehicle and user data relating to a user of the vehicle in the navigation program,
entering the destination into the navigation program by the user,
determining a route to the destination with a route section to be covered by a vehicle transport of the vehicle by the navigation program,
determining an estimated time of arrival of the vehicle at a starting location of the vehicle transport by the navigation program, and
booking a vehicle transport following the estimated arrival time by the navigation program using stored vehicle data and/or user data.

The navigation program is, for example, a so-called app and is executed, for example, by a control unit of the vehicle or by a mobile end device such as a smartphone or a tablet computer of a user of the navigation program. In the method according to one embodiment of the invention, the navigation program provides the user with convenience functions in the event that a route determined for a vehicle to a destination has a route section to be covered by a vehicle transport of the vehicle. These convenience functions comprise the determination of an estimated arrival time of the vehicle at a starting point of the vehicle transport by the navigation program, the determination of possible vehicle transports of the vehicle following the estimated arrival time for covering the route section and the provision of a selection option for the user to select one of the determined possible vehicle transports by the navigation program. This relieves the user of the burden of having to find out about possible and timely vehicle transports himself or to call up another application, i.e. another computer program (different from the navigation program), which provides this information. As a further convenience function, the navigation program books the vehicle transport selected by the user, so that the user is also relieved of the task of booking this vehicle transport.

In one embodiment of the invention, determining the route to the destination with a route section to be covered by a vehicle transport of the vehicle includes the following steps:
determining a plurality of possible routes to the destination by the navigation program, wherein at least one route comprises a route section to be covered by a vehicle transport of the vehicle,
providing the user with a selection option for selecting one of the possible routes by the navigation program, and
selecting a route by the user which has a route section to be covered by a vehicle transport of the vehicle.

This embodiment of the invention relates to cases in which several possible routes to the destination exist and are determined by the navigation program, at least one route having a route section to be covered by a vehicle transport of the vehicle, but other routes could also enable the destination to be reached without a vehicle transport. In such a case, the user of the navigation program is offered by the navigation program to select one of these determined routes. If the user selects a route with a route section to be covered by transporting the vehicle, the navigation program provides the user with the above-mentioned convenience functions for the selected route. This embodiment of the invention can therefore be summarized as follows:

In accordance with another aspect of an embodiment, a method for navigating a vehicle to a destination using a satellite-based navigation program, the journey to the destination comprising a vehicle transport of the vehicle, includes the steps of:
storing vehicle data relating to the vehicle and user data relating to a user of the navigation program in the navigation program,
entering the destination into the navigation program by the user,
determining a plurality of possible routes to the destination by the navigation program, at least one route having a route section to be covered by a vehicle transport of the vehicle,
providing the user with a selection option for selecting one of the possible routes by the navigation program,
selecting a route by the user and, if the selected route has a route section to be covered by a vehicle transport of the vehicle,
determining an estimated time of arrival of the vehicle at a starting location of the vehicle transport for the selected route by the navigation program,
determining, based on the estimated arrival time, possible vehicle transports of the vehicle for covering the route section of the selected route, and providing a selection option for the user to select one of the determined possible vehicle transports by the navigation program,
selecting one of the determined possible vehicle transports by the user, and
booking the selected vehicle transport by the navigation program using stored vehicle data and/or user data.

In a further embodiment of the invention, the vehicle is transported by means of a watercraft or a rail vehicle. Watercraft, for example ferries, or rail vehicles, for example trains equipped for the simultaneous transportation of vehicles and passengers, are frequently used for vehicle transportation. Therefore, the invention is particularly directed to vehicle transportation carried out by means of watercraft or rail vehicles.

In a further embodiment of the invention, booking the selected vehicle transportation includes reserving the vehicle transportation. This embodiment of the invention takes into account that a vehicle transport often requires a reservation of a transportation space for the vehicle or, for example, due to limited capacities and/or relatively infrequent trips of means of transport performing vehicle transports, a reservation of a transportation space for the vehicle is recommended. The reservation of a transport space for the vehicle by the navigation program also relieves the user of the task of making such a reservation.

In a further embodiment of the invention, the user data includes payment data of the user of the navigation program and the booking of the selected vehicle transport includes payment of the vehicle transport. In this way, the navigation program also relieves the user of the task of paying for the vehicle transport

In a further embodiment of the invention, the vehicle data includes a vehicle type, a maximum mass and/or dimensions of the vehicle and/or information about a trailer of the vehicle. This embodiment of the invention takes into account that a vehicle transportation may be bound to certain conditions regarding the vehicle type, mass, dimensions and/or a trailer of the vehicle. Some or all of said vehicle data may therefore be useful or even necessary for determining a route with a vehicle transport, determining possible vehicle transports and/or booking a selected vehicle transport.

In a further embodiment of the invention, the navigation program only determines as possible vehicle transports of the vehicle those vehicle transports which begin at least a buffer period stored in the navigation program later than the expected arrival time of the vehicle at the start location of the vehicle transport. For example, the user of the navigation program is provided by the navigation program with the option of defining and/or changing the buffer period. This embodiment of the invention takes into account that the actual arrival time of the vehicle at the starting location of the vehicle transport may deviate from the estimated arrival time determined by the navigation program. The buffer period counteracts the risk that the vehicle may miss the selected vehicle transport due to a delayed arrival at the starting location of the vehicle transport.

In a further embodiment of the invention, the navigation program checks whether the estimated time of arrival of the vehicle at the starting location of the vehicle transport changes and, if the estimated time of arrival increases by a delay period, the user is informed by the navigation program by means of a delay message. The delay period is, for example, the period between the expected arrival time of the vehicle at the start location of the vehicle transport and an expected start of the selected vehicle transport. Alternatively, the delay period coincides with the buffer period, for example. By notifying the user of an imminent late arrival at the start location of the vehicle transport, the user can initiate measures to counteract the delay, for example by increasing the driving speed, shortening or skipping planned intermediate stops and/or changing the route to the start location of the vehicle transport.

In a further embodiment of the invention, if the vehicle is delayed at the starting location of the vehicle transport by the delay period, the navigation program checks whether it is possible to rebook the vehicle transport to a later date for the vehicle and, if the rebooking is possible, the navigation program offers the user the rebooking and, if the user accepts the offer of the rebooking, the rebooking is carried out by the navigation program. The rebooking of the vehicle transport comprises, for example, a reservation of the changed vehicle transport. In this embodiment of the invention, the navigation program therefore rebooks the vehicle transport to a later date in the event of an imminent late arrival at the starting location of the vehicle transport, provided that such a rebooking is possible and is confirmed by the user.

In a further embodiment of the invention, when providing a selection option for the user to select one of the determined possible vehicle transports, the navigation program also provides the user with transport information for each determined possible vehicle transport. The transport information for a determined possible vehicle transport includes, for example, costs and/or an expected start and/or a duration of the possible vehicle transport. This provides the user with criteria that can be used to select one of several possible vehicle transports.

### BRIEF DESCRIPTION OF DRAWINGS

Embodiments of the invention are explained in more detail below with reference to drawings.

FIG. 1 shows a flow chart of one embodiment of the method according to the invention,

FIG. 2 shows an area and routes for a vehicle to a destination.

### DETAILED DESCRIPTION OF EXAMPLE EMBODIMENTS

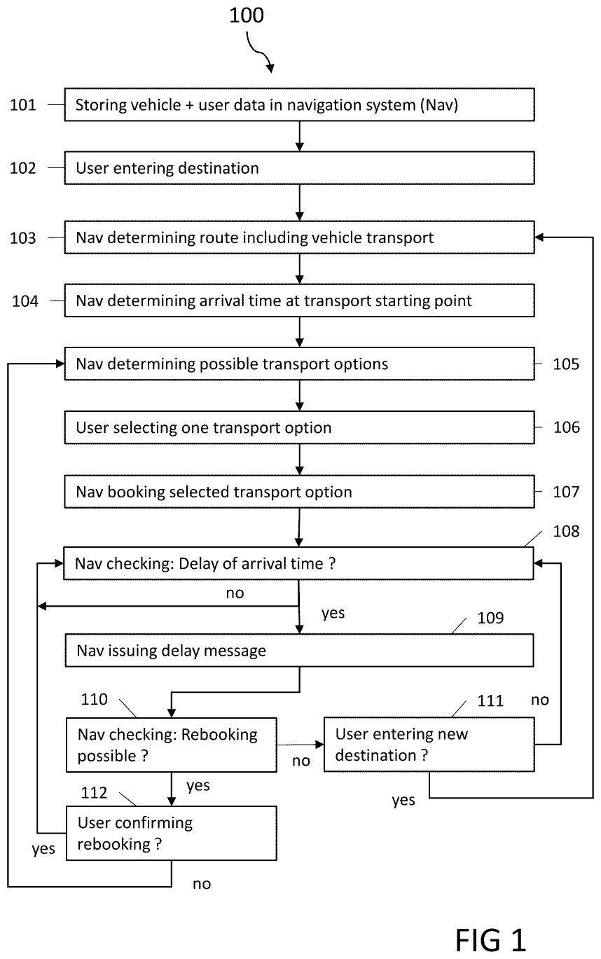

FIG. 1 shows a flowchart 100 of an embodiment of the method according to the invention with method steps 101 to 112 for navigating a vehicle to a destination using a satellite-based navigation program, wherein the journey to the destination comprises a vehicle transport of the vehicle.

In a first method step 101, vehicle data relating to the vehicle and user data relating to a user of the navigation program are stored in the navigation program. The vehicle data comprises, for example, a vehicle type, a maximum mass and/or dimensions of the vehicle and/or information about a trailer of the vehicle. The user data comprises, for example, payment data of the user of the navigation program. The first method step 101 need not be executed each time the navigation program is called. For example, in the first method step 101, the vehicle data and user data are stored in a user profile that is used by the navigation program each time the navigation program is called by the user.

In a second process step 102, the user enters the destination into the navigation program. After the second process step 102, a third process step 103 is carried out.

In the third method step 103, the navigation program determines a route to the destination with a route section to be covered by a vehicle transport of the vehicle.

The navigation program can initially determine several possible routes to the destination, whereby at least one route has a route section to be covered by a vehicle transport of the vehicle. In this case, the navigation program provides the user with a selection option for choosing one of the possible routes. For example, the possible routes are shown to the user on a display unit in the form of a selection menu. The user then selects one of these routes. In the following, it is assumed that the user selects a route with a route section to be covered by a vehicle transport of the vehicle, to which the further method steps 104 to 112 relate.

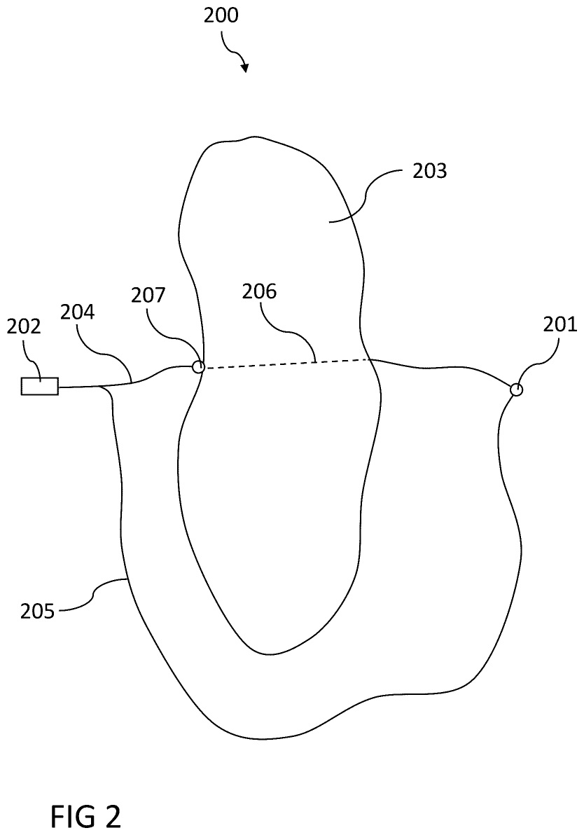

FIG. 2 shows an example of an area 200 with a destination 201 for a vehicle 202. In the area 200, there is a lake 203 between the vehicle 202 and the destination 201. In this example, the navigation program initially determines two routes 204, 205 for the vehicle 202 to the destination 201. A first route 204 has a route section 206 to be covered by a vehicle transport of the vehicle 202, which is shown in FIG. 2 by a dashed line. On this route section 206, the vehicle 202 is transported, for example, by a watercraft, such as a ferry, from a starting location 207 of the vehicle transport across the lake 203. Alternatively, the vehicle 202 is transported on the route section 206, for example, by a rail vehicle traveling on a bridge above the lake 203 or through a tunnel below the lake 203. The second route 205 to the destination 201 bypasses lake 203, but is significantly longer than the first route 204.

After the third process step 103, a fourth process step 104 is carried out. In the following, reference is made to FIG. 2 in the description of the method steps 104 to 112, whereby this does not represent a restriction to the example shown in FIG. 2.

In the fourth method step 104, an estimated arrival time of the vehicle 202 at a starting location 207 of the vehicle transport is determined by the navigation program. After the fourth method step 104, a fifth method step 105 is performed.

In the fifth method step 105, the navigation program determines possible vehicle transports of the vehicle 202 following the estimated arrival time for covering the route section 206. The navigation program can provide the user with the option of defining or changing a buffer period between arrival at the start location of the vehicle transport and the start of a vehicle transport.

Furthermore, the navigation program provides the user with a selection option for selecting one of the determined possible vehicle transports, whereby a buffer period is taken into account. For example, the possible vehicle transports are shown to the user on a display unit in the form of a selection menu. When providing the selection option for selecting one of the determined possible vehicle transports, the navigation program also provides the user with transport information for each determined possible vehicle transport, for example. The transport information for a determined possible vehicle transport comprises, for example, costs and/or an expected start and/or a duration of the possible vehicle transport. After the fifth method step 105, a sixth method step 106 is carried out.

In the sixth method step 106, the user selects one of the determined possible vehicle transports. After the sixth method step 106, a seventh method step 107 is carried out.

In the seventh method step 107, the selected vehicle transport is booked by the navigation program using stored vehicle data and/or user data. Booking the selected vehicle transportation may comprise reserving and/or paying for the selected vehicle transportation. If a vehicle transport has already been booked for the vehicle 202 and a rebooking of the vehicle transport is possible and confirmed by the user (see method steps 110 and 112), the rebooking of the vehicle transport is carried out in the seventh method step 107. After the seventh process step 107, an eighth process step 108 is carried out.

In the eighth method step 108, the navigation program checks whether the estimated arrival time of the vehicle 202 at the starting location 207 of the vehicle transport is increased by a delay period. The delay period is, for example, the period between the expected arrival time of the vehicle 202 at the starting location of the vehicle transport and an expected start of the selected vehicle transport. The navigation program checks the estimated time of arrival of the vehicle 202 at the starting location of the vehicle transport preferably at regular intervals or in response to new incoming traffic jam messages relating to the current route. In this case, the eighth method step 108 is repeated. Otherwise, a ninth procedural step 109 is carried out after the eighth procedural step 108.

In the ninth method step 109, the user is informed by the navigation program of the expected delay at the starting location 207 of the vehicle transport by the delay period by means of a delay message. After the ninth method step 109, a tenth method step 110 is performed.

In the tenth process step 110, the navigation program checks whether it is possible to rebook the vehicle transport to a later date for the vehicle 202. If it is not possible to rebook the vehicle transport to a later date, an eleventh process step 111 is executed after the tenth process step 110. Otherwise, a twelfth procedural step 112 is carried out after the tenth procedural step 110.

In the eleventh process step 111, the user is informed by the navigation program that it is not possible to rebook the vehicle transport to a later date. This information is output to the user, for example, by the navigation program in the form of a visual and/or acoustic message. Furthermore, in the eleventh method step 111, the user is asked by the navigation program whether a new route to the destination 201 should be determined. For example, the user is offered to answer the question in the affirmative or in the negative by means of a selection menu shown on a display unit. If the user answers the question in the negative, the eighth procedural step 108 is executed again after the eleventh procedural step 111, for example after a waiting period defined in the navigation program. Otherwise, a twelfth procedural step 112 is executed after the eleventh procedural step 111.

In the twelfth method step 112, the user is asked by the navigation program whether a rebooking of the vehicle transport is to be carried out by the navigation program. For example, the user is offered to answer the question in the affirmative or in the negative by means of a selection menu shown on a display unit. If the user answers the question in the negative, the eighth procedural step 108 is executed again after the twelfth procedural step 112, for example after a waiting period defined in the navigation program. Otherwise, after the twelfth procedural step 112, the fifth procedural step 105 is executed again, wherein the fifth procedural step 105 is now executed for an estimated arrival time of the vehicle 202 at the starting location 207 of the vehicle transportation, which is changed according to the estimated delay of the vehicle 202 at the starting location 207 of the vehicle transportation compared to the previously calculated arrival time.

### LIST OF REFERENCE SYMBOLS

100 Flow chart
101 to 112 Process step
200 Area
20 Destination
202 Vehicle
203 Lake
204 First route
205 Second route
206 Route section of the vehicle transport
207 Starting point of the vehicle transport

What is claimed is:

1. A method for navigating a vehicle using a satellite-based navigation program to a destination, wherein the journey to the destination comprises a vehicle transport of the vehicle, comprising the steps of:
storing vehicle data relating to the vehicle and user data relating to a user of the vehicle in the navigation program,
entering the destination into the navigation program by the user,
determining a route to the destination with a route section to be covered by a vehicle transport of the vehicle by the navigation program,
determining an estimated time of arrival of the vehicle at a starting location of the vehicle transport by the navigation program, and
booking a vehicle transport following the estimated arrival time by the navigation program using stored vehicle data and/or user data.

2. The method according to claim 1, wherein determining the route to the destination comprises the following steps:
determining a plurality of possible routes to the destination by the navigation program, wherein at least one route comprises a route section to be covered by a vehicle transport of the vehicle,
providing a selection option for the user for selecting one of the possible routes by the navigation program, and
selecting a route by the user which comprises a route section (206) to be covered by a vehicle transport of the vehicle.

3. The method according to claim 1, wherein the booking of a vehicle transportation following the estimated time of arrival comprises the following steps:
determining possible vehicle transports of the vehicle following the estimated time of arrival for covering the route section, and providing a selection option for the user to select one of the determined possible vehicle transports by the navigation program, and
selecting one of the determined possible vehicle transports by the user.

4. The method according to claim 1, wherein the vehicle is transported by means of a watercraft or a rail vehicle during the vehicle transportation.

5. The method according to claim 1, wherein booking the selected vehicle transportation comprising reservation of the vehicle transportation.

6. The method according to claim 1, wherein the booking of the selected vehicle transportation comprises payment of the vehicle transportation and the user data comprises payment data of the user.

7. The method according to claim 1, wherein the vehicle data comprises a vehicle type, a maximum mass and/or dimensions of the vehicle and/or information about a trailer of the vehicle.

8. The method according to claim 1, wherein the navigation program determining as possible vehicle transports only transports, which start at least after a buffer period, defined in the navigation program, to the expected arrival time of the vehicle at the starting location of the vehicle transport.

9. The method according to claim 1, wherein the navigation program checks whether the estimated time of arrival of the vehicle at the starting location of the vehicle transport is delayed, and, if so, the user is informed by the navigation program with a delay message.

10. The method according to claim 9, wherein, in the event of a delay of the vehicle at the starting location of the vehicle transport, the navigation program offers a rebooking of the vehicle transport to a later time and, if the user accepts the offer of the rebooking, the rebooking is carried out by the navigation program.

11. The method according to claim 1, wherein, when providing a selection option for the user to select one of the determined possible vehicle transports, the user is also provided with transport information for each determined possible vehicle transport by the navigation program.

12. The method according to claim 11, wherein the transport information for a determined possible vehicle transport comprises costs and/or an expected start and/or a duration of the possible vehicle transport.

13. A method for navigating a vehicle to a destination using a satellite-based navigation program, the journey to the destination comprising a vehicle transport of the vehicle, includes the steps of:
storing vehicle data relating to the vehicle and user data relating to a user of the navigation program in the navigation program,
entering the destination into the navigation program by the user,
determining a plurality of possible routes to the destination by the navigation program, at least one route having a route section to be covered by a vehicle transport of the vehicle,
providing the user with a selection option for selecting one of the possible routes by the navigation program,
selecting a route by the user and, if the selected route has a route section to be covered by a vehicle transport of the vehicle,
determining an estimated time of arrival of the vehicle at a starting location of the vehicle transport for the selected route by the navigation program,
determining, based on the estimated arrival time, possible vehicle transports of the vehicle for covering the route section of the selected route, and providing a selection option for the user to select one of the determined possible vehicle transports by the navigation program,
selecting one of the determined possible vehicle transports by the user, and
booking the selected vehicle transport by the navigation program using stored vehicle data and/or user data.
